(19) United States
(12) Patent Application Publication
(10) Pub. No.: US 2006/0013155 A1
(43) Pub. Date: Jan. 19, 2006

(54) Method and system for identifying a defective cable modem in an S-CDMA environment

(76) Inventor: Lawrence Spaete JR., Aurora, IL (US)

Correspondence Address: ARRIS INTERNATIONAL, INC, 3871 LAKEFIELD DRIVE, SUWANEE, GA, 30024, US

(21) Appl. No.: 11/182,555

(22) Filed: Jul. 15, 2005

Related U.S. Application Data
(60) Provisional application No. 60/588,063, filed on Jul. 15, 2004.

(51) Int. Cl. H04B 7/216

(52) U.S. Cl. 370/320

(57) ABSTRACT

Using a statistics-based assumption that a defective user device and a non-defective user device are not likely to transmit upstream data bursts during a given S-CDMA frame, a bad-burst count is incremented for each of a plurality of user devices that transmit an upstream burst during a frame when all bursts in the frame are deemed corrupt. If a given user device transmits an upstream burst in a frame having some non-corrupt bursts, the counter for that user device is cleared. When the count for any given device exceeds an associated predetermined threshold, that device is denied access to network resources so that performance of other properly performing devices is not degraded. Defective devices are identified to maintenance personnel for repair or replacement, and/or a defective device message can be sent downstream to the user device to alert the user that the device may need repair or replacement.

### CROSS REFERENCE TO RELATED APPLICATION

This application claims priority under 35 U.S.C. 119(e) to U.S. provisional patent application No. 60/588,063 entitled “Bad S-CDMA CM Identification Tool”, which was filed Jul. 15, 2004, and is incorporated herein by reference in its entirety.

### FIELD OF THE INVENTION

This invention relates, generally, to communication devices and, more particularly, to facilitating maintenance and diagnosis of customer premise devices, such as, for example, cable modems in a DOCSIS™ or EuroDOCSIS™ network.

### BACKGROUND

Network interface user devices, such as, for example, cable modems, are one way that multiple services operators (“MSO”) have been meeting the demand for increased bandwidth capabilities in delivering information over networks from a central location, such as a head end, to users, such as residential and commercial end-users. To facilitate such information delivery, standards have been developed that allow equipment from different manufacturers to operate, or ‘talk,’ with one another. The predominant standard used in the cable modem industry is known as Data Over Cable Service Interface Specification, or (“DOCSIS”), for use in delivering digital data, such as internet information, to users over the existing coaxial lines of the Community Antenna Television system (“CATV”), which has been delivering cable television programming to users at least since the 1960's.

As the DOCSIS standard evolves, more features are added that increase reliability, user-friendliness and performance. For example, DOCSIS version 2.0 facilitates use of a variety of upstream channel types to the network environment to enhance performance. One such channel type is Synchronous Code Division Multiple Access (“S-CDMA”), which is known in the art. In contrast to the conventional upstream channel environment, where Time Division Multiple Access (“TDMA”) has individual users exclusively transmit information towards the head end during discrete intervals, S-CDMA allows multiple users to transmit towards the head-end over the same upstream channel simultaneously.

Although S-CDMA is known to those skilled in the art, a brief overview using an S-CDMA channel is provided here for reference. Upstream transmission of information over an S-CDMA channel is broken down into small periods within S-CDMA frames. Within an S-CDMA frame, there are 128 codes where a code represents an opportunity for a user device, such as a cable modem, to transmit in the upstream direction. One or more of these codes can then be bundled together into a minislot. A modem is typically granted a predetermined number of minislots for transmitting upstream towards the head end via the MAP message that is sent by the CMTS in corresponding downstream data. More details of this can be found in the DOCSIS Radio Frequency Interface Specification.

An advantage of using S-CDMA in the upstream direction is that multiple modems may attempt to transmit simultaneously. Additionally, signals are less affected by noise. Thus, the effective signal-to-noise ratio is improved. However, since the S-CDMA technique spreads multiple user's signals across an S-CDMA frame using a plurality of spreading codes that are orthogonal to one another, a single bad modem can corrupt the transmission of all the other modems that are attempting simultaneous communication with the CMTS.

Currently, chipsets for the Cable Modem Termination System (“CMTS”) used in the DOCSIS environment facilitate modems completing the ranging information using TDMA. Thus, when a given modem performs this station maintenance, it is the only device communicating with the CMTS. From time to time, modems fail such that they continue to perform station maintenance while registered and trying to pass data on the system. However, such defective modems do not properly communicate with the CMTS when they are communicating at the same time as other modems. Information transmitted during such periods of improper communication corrupt S-CDMA frames also containing data from other modems that may be functioning properly.

One failure scenario is that a modem fails such that it cannot properly communicate even during station maintenance. Under this scenario, a defective modem is required via the DOCSIS specification to stop attempting to pass data and to attempt to re-register with the CMTS after 35 seconds. Consequently, if a modem fails under this scenario such that it cannot talk properly at all with the CMTS, the situation will correct itself after 35 seconds.

However, a second failure scenario exists where a modem continues to perform station maintenance, but does not communicate properly with other modems. A particular defective modem that has failed under this second scenario can remain in this state indefinitely, thereby indefinitely corrupting S-CDMA frames containing data from other devices that may be functioning properly. Therefore, there is a need for a method for identifying when a modem has failed such that it can perform station maintenance, but otherwise corrupts S-CDMA frames containing information from other devices that may be functioning properly.

### SUMMARY

It is an object to provide a method for denying network access to a defective user device, such as a cable modem, that can perform station maintenance using TDMA, but corrupts S-CDMA frames of other devices that are performing properly. After using its capability to determine that all the data that was received in given S-CDMA frame has been corrupted, the CMTS can then determine what Service Identifiers (“SID”)—which are associated with a particular user device as known in the art—were allowed to transfer information during the given S-CDMA frame boundary. Since the CMTS can translate from SIDs to particular user devices, such as cable modems, it can determine which modems tried to transmit during any specific S-CDMA frame boundary.

The CMTS determines which particular devices, or modems, for example, transmit during an S-CDMA frame that contains corrupted data, and increments a counter for these devices when a complete frame has been received. The counters corresponding to these devices are cleared if one of said devices transmits during an S-CDMA frame where not all of the data bursts in a given S-CDMA frame is corrupt. The counters are evaluated to determine which devices, or modems, continuously transmit in a S-CDMA frame where the entire S-CDMA frame has been corrupted. When the counter corresponding to a particular device reaches a predetermined threshold, the modem is determined to be defective, and is thenceforth denied access to the network, so as to prevent further corrupting of data being sent by properly operating devices.

### BRIEF DESCRIPTION OF DRAWINGS

FIG. 1 shows a flow diagram of a process for denying network access to defective devices.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

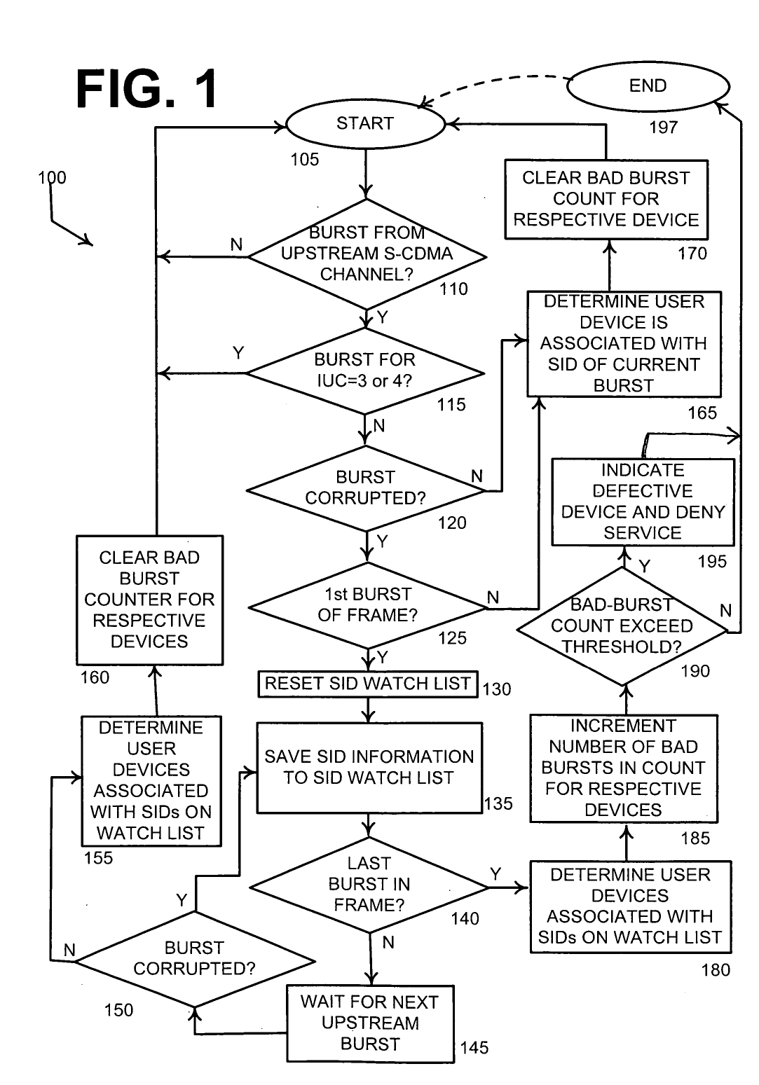

Turning now to the figures, FIG. 1 illustrates a flow diagram of a method 100 for identifying defective user devices, or cable modems, in an S-CDMA operating environment network having a plurality of user devices coupled to central network equipment, such as, for example, a cable modem termination system (“CMTS”). Method 100 starts receiving data/information bursts at step 105. When an upstream burst is received at the CMTS, the burst is evaluated at step 110 to determine whether it arrived over a S-CDMA channel. If no, process 100 returns to step 105 to receive more bursts. If the evaluation at step 110 determines that the burst is an S-CDMA burst, then the process advances to step 115.

At step 115, an evaluation is made to determine whether the burst received at step 105 contains information related to either interval usage code (“IUC”) 3 or 4, which correspond to a request burst and a station ranging burst, respectively. If the evaluation at step 115 determines that the evaluated burst contains IUC 3 or 4 information, then process 100 returns to step 105 to receive more bursts. Otherwise, process 100 advances to step 120 to determine whether the burst contains corrupt data.

If the burst under evaluation at step 120 contains valid data, then process 100 proceeds to step 165. At step 165, the service identifier (“SID”) associated with the burst is cross-referenced at the CMTS to determine which modem transmitted the burst. In this case, since the burst contains valid data and therefore the entire S-CDMA is not corrupted, a bad burst counter, corresponding to each SID, and thus to each user device served by the CMTS, resets to zero at step 170.

However, if the burst under evaluation in step 120 does contain corrupt data, process 100 proceeds to step 125. At step 125, a determination is made whether a burst is the first burst in a S-CDMA frame. An S-CDMA frame does not contain bursts for IUC 3 or 4, and bursts for other IUCs, per S-CDMA specifications found in the DOCSIS Radio Frequency Interface Specification and the design of currently available chipsets. Thus, a burst that passes through steps 110, 115 and 120 that is not the first burst of the frame, as determined at step 125, means that other bursts in the same frame were non-corrupted, non-IUC 3 or 4 S-CDMA bursts. Therefore, since there were valid bursts already in this same S-CDMA frame, bad-burst counters associated with user devices that transmitted bursts in the S-CDMA frame in which not all bursts are corrupt are reset at step 165.

If the burst being evaluated at step 125 is the first burst of the frame, then a service identifier (“SID”) watchlist is cleared/reset at step 130. The SID watch list is a database maintained by the CMTS that can record service identifiers that are contained in the upstream bursts of the current S-CDMA frame. As known in the art, a SID is associated with a particular modem by the CMTS for identification purposes, among others. SIDs stored to the watch list indicate user devices that have transmitted corrupt data bursts in a given frame.

Because process 100 has reached step 130, then no other bursts associated with the current frame have met the criteria of the previous steps that would cause the process to return to step 105. However, since the current burst is the first burst of the current frame, no SIDs other than the SID associated with the current burst under evaluation should be in the watch list. Thus, the SID watch list is reset at step 130 and the SID associated with the current burst is added to the watch list at step 135.

After the SID watch list has been cleared at step 130 and the current burst added thereto at step 135, process 100 proceeds to step 140, where a determination is made whether the current burst is the last burst in the S-CDMA frame. If step 140 determines that the current burst is the last burst in the S-CDMA frame, only one user device transmitted via one SID during the S-CDMA frame. Process 100 proceeds to step 180 to determine which user devices are associated with the SIDs on the watch list.

At step 180, a cross-reference is used to determine which modems are associated with the SIDs on the watch list. After completing step 180, a bad-burst counter corresponding to each user device is incremented at step 185 for all user devices that are identified by associated SIDs in the watch list.

At step 190, a determination is made whether predetermined thresholds corresponding to each of the user devices have been exceeded. The predetermined thresholds may be different and specific for each of the plurality of user devices, and are used for deeming a given modem to be defective. If the count for one or more devices exceeds the respective predetermined threshold(s) of bad bursts, then that one or more device(s) is/are deemed to be defective and is/are denied access to the network at step 195. This prevents degradation of performance to other user devices that are performing properly as discussed above. A message may be transmitted to defective user devices indicating to the respective user that their equipment is defective. A message may also be transmitted to the MSO so that maintenance personnel can be notified and corrective action taken. The process ends at step 197.

If the result of the evaluation at step 190 is no, process 100 ends at step 197.

Returning to the description of the determination made at step 140, if the burst under evaluation at step 140 is determined to not be the last burst in the S-CDMA frame, then process 100 advances to step 145 and waits for the next burst. Upon receiving the next burst, process 100 proceeds to step 150, where a determination is made whether the burst contains corrupt data. If the burst does not contain corrupt data, process 100 advances to step 155. It will be appreciated that step 155 is functionally similar to step 180.

At step 155, process 100 has received some corrupted bursts in the S-CDMA frame. However, not all of the bursts are corrupt because the last burst evaluated at step 150 is not corrupt. Consequently, a cross-reference is used to determine which modems are associated with the SIDs on the watch list at step 155. This information is used to clear the bad burst count at step 160 for each modem with an associated SID saved on the watch list. After completing step 160, process 100 returns to step 105.

Returning to the description of the evaluation at step 150, if the burst being evaluated is determined to be corrupt, process 100 returns to step 135, where the SID of the current burst is saved to the SID watch list, as described above. Thus, the SID of the current burst is added to other SIDs that may already be saved to the watch list

Process 100 uses the statistically probable assumption that only a limited number of user devices typically attempt to transmit during a given S-CDMA frame. It is further assumed, based on statistical probability, that a defective user device and a non-defective user device typically will not repeatedly attempt transmission during the same frame, frame-after-frame. Thus, if a non-defective burst is detected for a given frame at step 150, then it is assumed that none of the devices that may have transmitted in that same frame are defective. Thus, the bad burst counters for the SIDs that were added to the watch list during an iteration—corresponding to a given frame—of process 100 are cleared at step 160. Although this assumption may be incorrect for a given iteration, statistically, the determination of a non-corrupt burst being in the same frame as a corrupt burst is not likely. Thus, all bursts in another frame containing a burst from the defective user device will likely be determined as corrupt due to the likely destruction of orthogonality between bursts of respective user devices caused by the corrupt burst, and process 100 will proceed from step 150 to step 135.

Regarding the threshold, it will be appreciated that the predetermined threshold may vary for different user devices as desired by the MSO. The higher the threshold, the lower the probability of falsely detecting a defective user device. After a device or devices is/are deemed defective at step 195, when a defective device message may be transmitted to one or more user devices having bad burst counts that exceed their respective predetermined thresholds, process 100 ends at step 197. Process 100 may then return to step 105 and continue evaluating upstream data bursts from user devices that have not been denied access.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents. The subject matter discussed above may apply to communication network environments other than just cable modem termination system networks. For example, some wireless telephony networks use S-CDMA. Thus, the described subject matter may apply to mobile user devices and base stations used therewith.

What is claimed is:

1. A method for identifying a defective user device in an S-CDMA operating environment network having a plurality of user devices coupled to central network equipment, comprising:
adding to a watch list an identifier corresponding to a user device that transmitted a corrupt burst to the central network equipment;
incrementing a bad-burst count corresponding to devices identified in the watch list when all data bursts within an S-CDMA frame are corrupt;
determining whether the bad-burst count corresponding to a given user device exceeds a predetermined threshold associated with the given device; and
denying network access to user devices for which corresponding bad burst counts exceed the respective predetermined thresholds.

2. The method of claim 1 wherein the user device includes a cable modem.

3. The method of claim 1 wherein the user device includes a mobile wireless device.

4. The method of claim 1 wherein the central network equipment includes a CMTS.

5. The method of claim 1 wherein the central network equipment includes a wireless base station.

6. The method of claim 1 further comprising:
clearing the bad-burst count for user devices identified in the watch list when all bursts within an S-CDMA frame are not corrupt;
clearing the watch list when all bursts within an S-CDMA frame are not corrupt.

7. The method of claim 1 further comprising determining that an upstream burst is not corrupt if it contains interval usage code information.

8. The method of claim 1 further comprising generating a message that one or more user devices are corrupt to user devices for which corresponding bad burst counts exceed the respective predetermined thresholds.

9. The method of claim 1 wherein the identifiers corresponding to a user devices include service identifiers.

10. A method for identifying a defective user device in an S-CDMA operating environment network having a plurality of user devices coupled to central network equipment, comprising:
identifying a data burst having corrupt data transmitted by one of the plurality of user devices to the central network equipment;
saving to a service identifier watch list a service identifier corresponding to the one of the plurality of user devices that transmitted the data burst having corrupt data;
incrementing a bad-burst count corresponding to each service identifier stored in the service identifier watch list when a complete frame of corrupt data bursts has been transmitted to the central network equipment;
determining for each service identifier saved in the service identifier watch list whether the bad-burst count exceeds a predetermined threshold; and
denying network access to user devices corresponding to the service identifiers stored in the service identifier watch list for which the corresponding bad-burst count exceeds the respective predetermined thresholds.

11. The method of claim 10 wherein the user device includes a cable modem.

12. The method of claim 10 wherein the user device includes a cable modem termination system.

13. The method of claim 10 further comprising:
clearing the bad-burst count for user devices identified in the watch list when all bursts within an S-CDMA frame are not corrupt;
clearing the watch list when all bursts within an S-CDMA frame are not corrupt.

14. The method of claim 10 further comprising determining that an upstream burst is not corrupt if it contains interval usage code information.

15. The method of claim 10 further comprising transmitting a defective device message to one or more users devices for which corresponding bad burst counts exceed the respective predetermined thresholds.

16. A method for identifying a defective user device in an S-CDMA operating environment network having a plurality of user devices coupled to central network equipment, comprising:
identifying a data burst having corrupt data transmitted by one of the plurality of user devices to the central network equipment;
saving to a service identifier watch list a service identifier corresponding to the one of the plurality of user devices that transmitted the data burst having corrupt data;
incrementing a bad-burst count corresponding to each service identifier stored in the service identifier watch list when a complete frame of corrupt data bursts has been transmitted to the central network equipment;
determining for each service identifier saved in the service identifier watch list whether the bad-burst count exceeds a predetermined thresholds;
denying network access to user devices corresponding to the service identifiers stored in the service identifier watch list for which the corresponding bad-burst count exceeds the respective predetermined thresholds;
clearing the bad-burst count for user devices identified in the watch list when all bursts within an S-CDMA frame are not corrupt;
clearing the watch list when all bursts within an S-CDMA frame are not corrupt; and
transmitting a defective device message to one or more user devices for which corresponding bad burst counts exceed the respective predetermined thresholds.

17. The method of claim 16 wherein the user device includes a cable modem.

18. The method of claim 16 wherein the user device includes a cable modem termination system.

19. The method of claim 16 further comprising determining that an upstream burst is not corrupt if it contains interval usage code information.
